(19) United States
(12) Patent Application Publication
(10) Pub. No.: US 2025/0258750 A1
(43) Pub. Date: Aug. 14, 2025

(54) DELAY ESTIMATION APPARATUS, DELAY ESTIMATION METHOD, AND DELAY ESTIMATION SYSTEM

(71) Applicant: Mitsubishi Electric Corporation, Tokyo (JP)

(72) Inventor: Junya SHIMADA, Tokyo (JP)

(73) Assignee: Mitsubishi Electric Corporation, Tokyo (JP)

(21) Appl. No.: 19/113,450

(22) PCT Filed: Oct. 14, 2022
(86) PCT No.: PCT/JP2022/038328

§ 371 Date: Mar. 20, 2025

(51) Int. Cl. G06F 11/34; G06F 11/07

(52) U.S. Cl. CPC G06F 11/3419; G06F 11/07

(57) ABSTRACT

An object is to provide a technique that a user can easily specify a part where a delay occurs in a microservice. A delay estimation apparatus includes an acquisition part and a determination part. The acquisition part acquires, for each of a plurality of queries, a response time of one or more microservices using the query for a data model in which the plurality of queries are previously associated. The determination part determines whether or not a delay occurs for each of the queries based on the response time currently acquired and the response time acquired in a past time.

### TECHNICAL FIELD

The present disclosure relates to a delay estimation apparatus, a delay estimation method, and a delay estimation system.

### BACKGROUND ART

Proposed in recent years are various techniques for an architecture dividing a plurality of functions into a plurality of microservices and combining the plurality of microservices to constitute a system such as cloud. For example, Patent Document 1 proposes a technique of determining a delay of a microservice.

### PRIOR ART DOCUMENTS

### Patent Document(s)

Patent Document 1: Japanese Patent Application Laid-Open No. 2021-196970

### SUMMARY

### Problem to be Solved by the Invention

Since a conventional technique focuses on a response time between microservices, a delay of a route of a microservice in which a delay occurs can be determined. However, the conventional technique does not determine which a query used in the microservices is delayed. Thus, there is a problem that a user needs to confirm relatively a wide range of a part where the delay occurs in the microservice in repairing, for example, and such a part cannot be easily specified.

The present disclosure is therefore has been made to solve problems as described above, and it is an object to provide a technique that a user can easily specify a part where a delay occurs in a microservice.

### Means to Solve the Problem

A delay estimation apparatus according to the present disclosure includes: an acquisition part acquiring, for each of a plurality of queries, a response time of one or more microservices using the query for a data model in which the plurality of queries are previously associated; and a determination part determining whether or not a delay occurs for each of the queries based on the response time currently acquired and the response time acquired in a past time.

### Effects of the Invention

According to the present disclosure, it is determined whether or not the delay occurs for each query based on the current response time and the past response time. According to such a configuration, a user can easily specify a part where the delay occurs in the microservice.

These and other objects, features, aspects and advantages of the present disclosure will become more apparent from the following detailed description and the accompanying drawings.

### BRIEF DESCRIPTION OF DRAWINGS

FIG. 1 is a block diagram illustrating a configuration of a delay estimation system according to an embodiment 1.

FIG. 2 is a diagram illustrating an example of data stored in a monitoring data management DB according to the embodiment 1.

FIG. 3 is a diagram illustrating an example of a data model stored in a data model management DB according to the embodiment 1.

FIG. 4 is a diagram illustrating an example of a response time stored in a history management part according to the embodiment 1.

FIG. 5 is a flow chart illustrating an operation of a delay estimation apparatus according to the embodiment 1.

FIG. 6 is a flow chart illustrating an operation of the delay estimation apparatus according to the embodiment 1.

FIG. 7 is a diagram illustrating an example of a response time stored in a history management part according to a modification example 3.

FIG. 8 is a block diagram illustrating a hardware configuration of a delay estimation apparatus according to another modification example.

FIG. 9 is a block diagram illustrating a hardware configuration of a delay estimation apparatus according to another modification example.

### DESCRIPTION OF EMBODIMENT(S)

### Embodiment 1

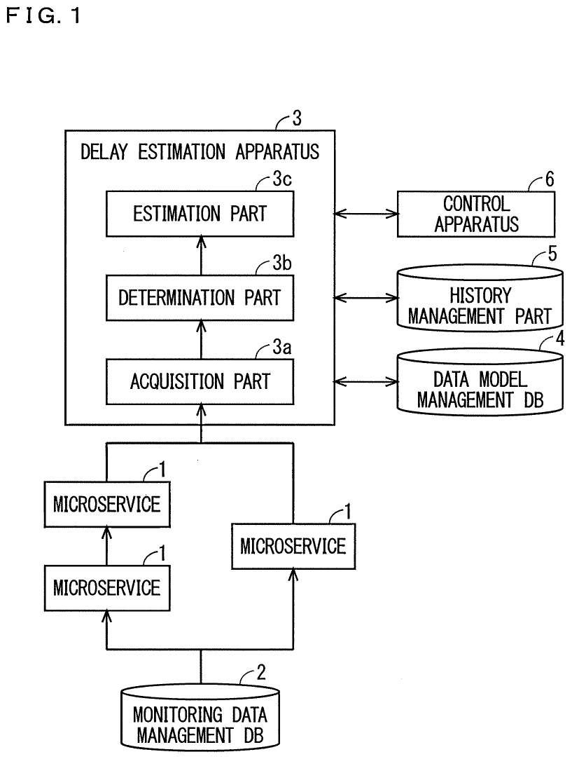

FIG. 1 is a block diagram illustrating a configuration of a delay estimation system according to the present embodiment 1. The delay estimation system in FIG. 1 includes a microservice 1, a monitoring data management DB 2, a delay estimation apparatus 3, a data model management DB 4, a history management part 5, and a control apparatus 6. The DB of the monitoring data management DB 2 and the data model management DB 4 indicates “database”.

The microservice 1 has a specific function, and the plurality of microservices 1 constitute a function system such as cloud having a desired function in which specific functions are combined. The microservice 1 performs processing of acquisition, search, and change, for example, on data stored in the monitoring data management DB 2 using a query, thereby achieving a specific function. The microservice 1 may perform processing of acquisition, search, and change, for example, on not only data stored in the monitoring data management DB 2 but also data processed by the other microservice 1 using a query, thereby achieving a specific function.

The microservice 1 uses one or more queries. Metadata such as a facility, a year, and a building, for example, is assigned to a name for identifying the query. For example, the microservice 1 performs processing of acquisition, search, and change, for example, on data regarding a year using a query to which a year is assigned as a name. In one microservice 1, the plurality of queries may be parallelly, serially, or selectively used.

The monitoring data management DB 2 stores data acquired, searched, or changed by the query of the microservice 1.

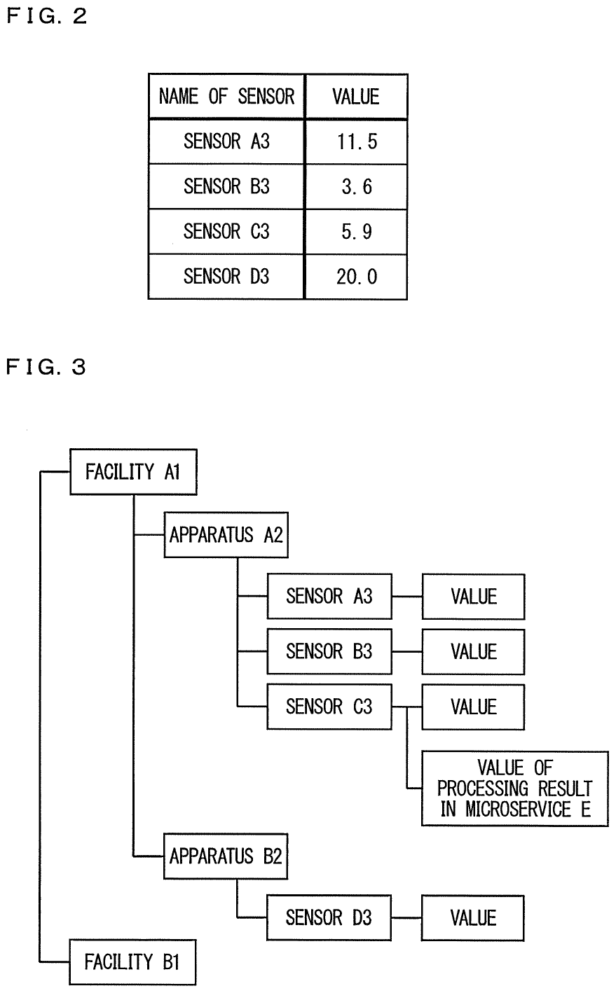

FIG. 2 is a diagram illustrating an example of data stored in the monitoring data management DB 2 according to the present embodiment 1. In the example in FIG. 2, a name of a sensor and a value such as a measured value of the sensor are associated with each other and stored. For example, when a plurality of tables in FIG. 2 are associated with each sensor and stored in the monitoring data management DB 2, and the microservice 1 uses the query of a sensor A3, the microservice 1 acquires data regarding the sensor A3 from the plurality of tables of the monitoring data management DB 2. The monitoring data management DB 2 is made up of a relational database, for example.

The delay estimation apparatus 3 in FIG. 1 estimates the delay of the query used by the microservice 1 in cooperation with the data model management DB 4 and the history management part 5 when the microservice 1 executes a specific function, for example. The delay estimation apparatus 3, the data model management DB 4, and the history management part 5 are described in detail hereinafter.

The delay estimation apparatus 3 includes an acquisition part 3a, a determination part 3b, and an estimation part 3c.

The acquisition part 3a acquires, for each query, the response time of one or more microservices 1 using the query for a data model in which the plurality of queries are previously associated. In the present embodiment 1, one or more microservices 1 includes one microservice 1 and the other microservice 1. In the present embodiment 1, the data model management DB 4 stores the data model.

FIG. 3 is a diagram illustrating an example of the data model stored in the data model management DB 4 according to the present embodiment 1. In the example in FIG. 3, the plurality of queries are previously associated in a hierarchy structure in the data model, and include a query of a facility, a query of an apparatus, and a query of a sensor sequentially defined from an upper hierarchy of the hierarchy structure. Although the data model is set by a user in the present embodiment 1, the configuration is not limited thereto.

In the example in FIG. 3, a query of a facility A1 is associated with a query of each of an apparatus A2 and an apparatus B2 lower than that of the facility A1. The query of the apparatus A2 is associated with a query of each of the sensors A3, B3, and C3 lower than that of the apparatus A2, and the query of the apparatus B2 is associated with a query of a sensor D3 lower than that of the apparatus B2. The query of each of the sensors A3, B3, C3, and D3 is associated to a value corresponding to a value in FIG. 2, and the query of the sensor C3 is further associated with a value obtained in a processing result of a microservice E.

For example, when the data model is set as illustrated in FIG. 3, the microservice 1 using the query of the facility A1 substantially uses the query of each of the apparatus A2 and the apparatus B2. In the similar manner, the microservice 1 using the query of the apparatus A2 substantially uses the query of each of the sensors A3, B3, and C3.

The acquisition part 3a in FIG. 1 acquires, for each query, the response time of the microservice 1 using the query for the data model in which the plurality of queries are previously associated. For example, when the microservice 1 uses the query of the sensor A3, the acquisition part 3a acquires the response time from a request of the query of the sensor A3 until a response in accordance with the data model in FIG. 3. For example, when the microservice 1 uses the query of the apparatus A2, the acquisition part 3a acquires the response time from a request of the query of each of the apparatus A2 and the sensors A3, B3, and C3 until a response in accordance with the data model in FIG. 3. The history management part 5 stores the response time acquired in the acquisition part 3a.

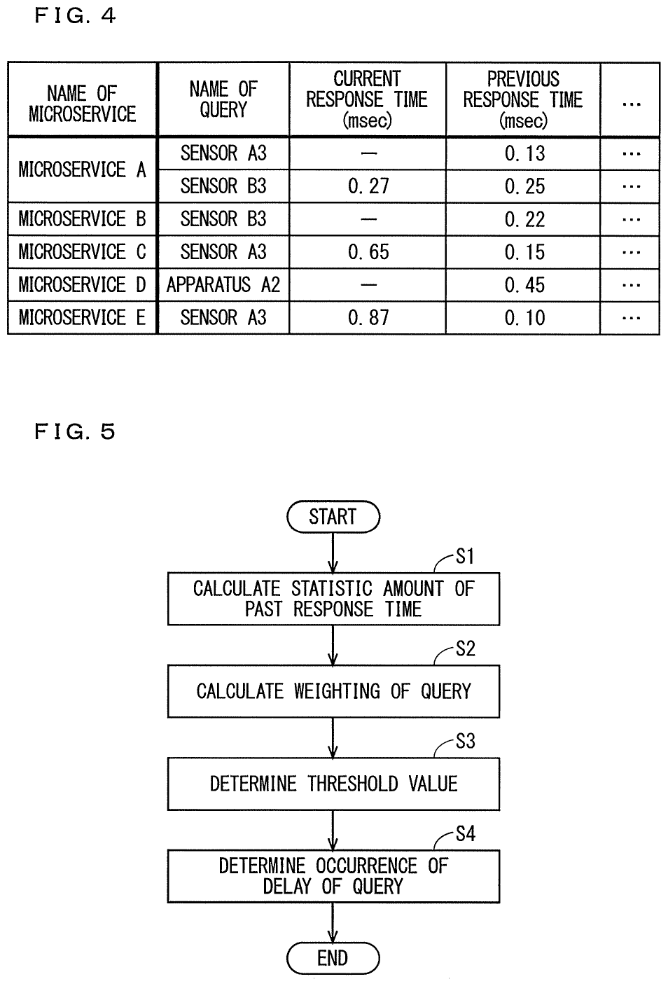

FIG. 4 is a diagram illustrating an example of the response time stored in the history management part 5 according to the present embodiment 1. The history management part 5 stores a current response time which has been acquired most recently and a preceding response time as an example of a past response time which has been acquired in the past.

The example in FIG. 4 illustrates that a microservice A selectively uses the query of the sensor A3 and the query of the sensor B3, and the current response time is acquired for the sensor B3. In the similar manner, the example in FIG. 4 illustrates that microservices C and E use the query of the sensor A3, and the current response time is acquired for the sensor A3. A difference of the response time between the microservices C and E using the same sensor A3 is caused by a difference other than the query of the sensor A3 such as a difference of network, for example.

The determination part 3b in FIG. 1 determines whether or not the delay occurs for each query based on the current response time and the past response time. In the present embodiment 1, the determination part 3b determines whether or not the delay occurs for each query based on the current response time and a threshold value.

FIG. 5 is a flow chart illustrating an operation of the determination part 3b according to the present embodiment 1. The operation in FIG. 5 is performed for each query when the microservice 1 uses the query and the acquisition part 3a acquires the response time.

Firstly, in Step S1, the determination part 3b performs statistic processing on the plurality of past response times to calculate a statistic amount of the past response times. The statistic amount is an average value, a center value, dispersion, or a standard deviation, for example.

In Step S2, the determination part 3b calculates weighting of the query. For example, the determination part 3b calculates a degree of importance of the query or a degree of importance of the microservice 1 using the query as the weighting of the query based on query information such as a usage frequency of the query.

In Step S3, the determination part 3b determines the threshold value based on the statistic value calculated in Step S1 and the weighting of the query calculated in Step S2.

In Step S4, the determination part 3b determines whether or not the delay occurs in the query in which the current response time is acquired based on the determination whether or not the current response time is larger than the threshold value determined in Step S3. In the present embodiment 1, the determination part 3b determines that the delay occurs in the query when the current response time is larger than the threshold value, and determines that the delay does not occur in the query when the current response time is equal to or smaller than the threshold value. Subsequently, the operation in FIG. 5 is finished.

In the operation described above, when the statistic amount is an average value, for example, the determination part 3b determines a sum or a product of the average value and a predetermined margin value as the threshold value. When only one past response time is acquired and the statistic amount in Step S1 cannot be calculated, the determination part 3b determines the sum or the product of a value of the past response time and a predetermined margin value as the threshold value. Then, the determination part 3b reduces the margin value as the weighting of the query, that is to say, a degree of importance of the query or the microservice gets larger. According to such a configuration, the determination of the delay of the query can be tightened more as the degree of importance of the query gets larger; thus, the delay of the query or the microservice 1 having a high degree of importance can be easily detected.

In the example in FIG. 4, the current response time is substantially the same as the previous response time in the microservice A using the query of the sensor B3; thus, the determination part 3b tends to determine that the delay does not occur in the query of the sensor B3. In the meanwhile, the current response time is significantly larger than the previous response time in the microservices C and E using the query of the sensor A3; thus, the determination part 3b tends to determine that the delay occurs in the query of the sensor A3.

In the description hereinafter, the query in which the determination part 3b determines that the delay occurs is referred to as “the delay query” in some cases for convenience of description.

The estimation part 3c in FIG. 1 determines that the delay occurs in both the microservice 1 using the delay query and the query associated with the delay query in the data model based on the data model and the delay query. The estimation of the estimation part 3c is not limited thereto, but the estimation part 3c may estimate that the delay occurs in not both the microservice 1 using the delay query and the query associated with the delay query in the data model but one of them.

In the present embodiment 1, the estimation part 3c estimates that the delay occurs in the query associated with the delay query and positioned in an upper hierarchy than the delay query in the hierarchy structure based on the data model and the delay query.

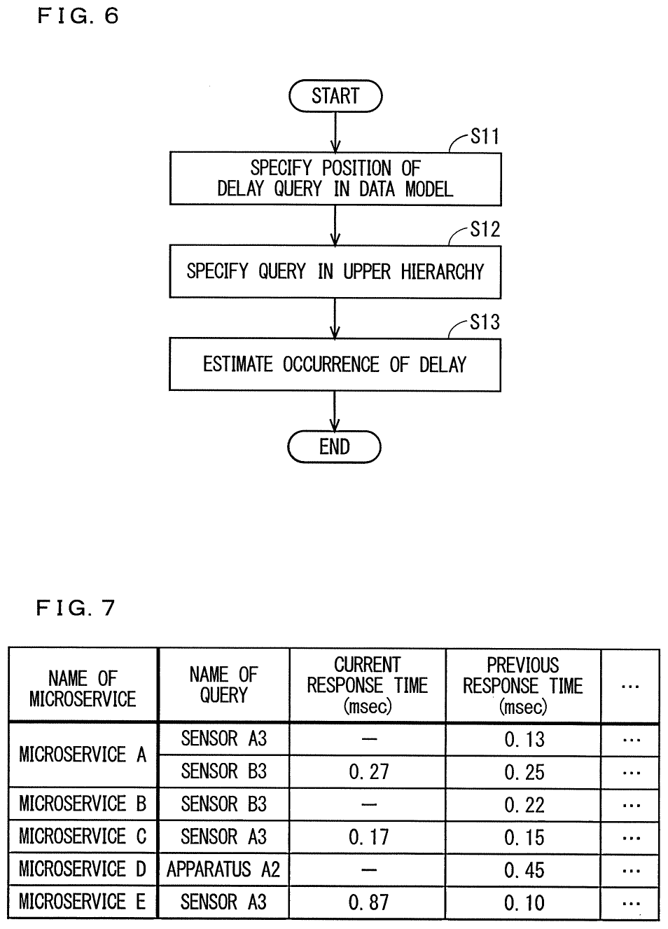

FIG. 6 is a flow chart illustrating an operation of the estimation part 3c according to the present embodiment 1. The operation in FIG. 6 is performed when the determination part 3b determines the delay query.

Firstly, in Step S11, the estimation part 3c specifies a position of the delay query in the data model.

In Step S12, the estimation part 3c specifies the query associated with the delay query and positioned in an upper hierarchy than the delay query in the hierarchy structure in the data model. For example, when the data model is the data model in FIG. 3 and it is determined that the query of the sensor A3 is the delay query, the estimation part 3c specifies the query of the apparatus A2 and the facility A1 in Step S12.

In Step S13, the estimation part 3c estimates that the delay occurs in the microservice 1 using the delay query and the query specified in Step S12. For example, assumed is a case where the data model is the data model in FIG. 3 and the query of the sensor A3 used by the microservice E in FIG. 4 is determined as the delay query. In this case, the estimation part 3c estimates that delay occurs in the microservice E in FIG. 4 and the query of the apparatus A2 and the facility A1 in Step S13. Subsequently, the operation in FIG. 6 is finished.

The control apparatus 6 in FIG. 1 performs control of making a display apparatus not shown in the diagrams display the determination result and the estimation result in the delay estimation apparatus 3. The control apparatus 6 stops the microservice 1 using the delay query determined in the delay estimation apparatus 3. For example, as with the example described above, when the query of the sensor A3 using the microservice E in FIG. 4 is determined as the delay query, the control apparatus 6 stops the microservice E in FIG. 4. The control apparatus 6 may stop all of function systems made by the microservice 1 using the delay query, or may also stop only the microservice 1 using the delay query in the function systems.

### Conclusion of Embodiment 1

According to the delay estimation apparatus 3 in the present embodiment 1 described above, it is determined whether or not the delay occurs for each query based on the current response time and the past response time. According to such a configuration, the query in which the delay occurs in the microservice 1 can be determined; thus, a user can easily specify a part where the delay occurs in the microservice 1.

In the present embodiment 1, it is estimated that the delay occurs in at least one of the microservice using the delay query and the query associated with the delay query in the data model based on the data model and the delay query. As an example thereof, it is estimated that the delay occurs in the query associated with the delay query and positioned in an upper hierarchy than the delay query in the hierarchy structure based on the data model and the delay query. According to such a configuration, time and effort of a user checking the data model and specifying the microservice using the delay query and the query associated with the delay query can be reduced.

In the present embodiment 1, the threshold value for determining whether or not the delay occurs for each query is determined based on the past response time and the weighting of the query. According to such a configuration, the determination of the delay can be tightened for the query or the microservice 1 having a high degree of importance.

In the present embodiment 1, the microservice using the delay query is stopped; thus, further occurrence of defect caused by the delay query can be suppressed.

### Modification Example 1

Although the plurality of queries in the data model in FIG. 3 according to the embodiment 1 include the group of the query of the facility, the query of the apparatus, and the query of the sensor sequentially defined from the upper hierarchy in the hierarchy structure, the configuration is not limited thereto. For example, the plurality of queries may include a group of a query of a year, a query of a month, and a query of a day sequentially defined from the upper hierarchy in the hierarchy structure, or may also include a group of a query of a building, a query of a floor, and a query of a person sequentially defined from the upper hierarchy in the hierarchy structure.

### Modification Example 2

In the embodiment 1, the estimation part 3c may estimate that the delay occurs in the other microservice 1 using the delay query when the delay query is determined in one microservice 1 based on the data model and the delay query. Then, the control apparatus 6 may stop the other microservice 1 using the delay query. For example, in FIG. 4, when the query of the sensor A3 is determined as the delay query in the microservice E, it may be estimated that the delay occurs in the microservices A and C using the query of the sensor A3, and the microservices A and C may be stopped. According to such a configuration, further occurrence of defect caused by the delay query can be suppressed.

### Modification Example 3

Assumed is a case where the modification example 2 is not applied in the embodiment 1 but the other microservice 1 uses the same query as the query used in one microservice. In such a case, it is determined that the delay occurs in the query in one microservice 1 and it is not determined that the delay occurs in the query in the other microservice. In this case, the estimation part 3c may estimates that the delay occurs in a part of one microservice 1 other than the query.

FIG. 7 is a diagram illustrating an example of the response time stored in the history management part 5 according to the present modification example 3. In FIG. 7, the current response time in the microservice C is changed to have a smaller value from that in FIG. 4.

For example, in FIG. 7, it is determined that the delay occurs in the query of the sensor A3 in the microservice E and it is not determined that the delay occurs in the query of the sensor A3 in the microservice C. In this case, the estimation part 3c may estimate that the delay does not occur in the query of the sensor A3 but the delay occurs in a part of the microservice E other than the query of the sensor A3 such as network of the microservice E, for example. According to such a configuration, a part where the delay occurs is estimated in more detail; thus, a user can easily specify a part where the delay occurs in the microservice.

### Modification Example 4

Although the number of data models in FIG. 3 is one in the embodiment 1, the plurality of data models may be included.

For example, the control apparatus 6 may perform mechanical learning including at least one of supervised learning, unsupervised learning, and enforced learning in which deep learning is used on names of the plurality of queries to create the data model.

The control apparatus 6 having such a configuration can associate a query to which a name “filter plant with circle mark, polluted mud area with triangle mark, sensor A3” is assigned and a query to which a name “filter plant with circle mark, polluted mud area with triangle mark, sensor B3” is assigned with a query to which a name “filter plant with circle mark, polluted mud area with triangle mark” is assigned. The control apparatus 6 can associate a query to which a name “filter plant with circle mark, polluted mud area with triangle mark” is assigned with a query to which a name “filter plant with circle mark” is assigned, for example. In this manner, the control apparatus 6 can automatically create the data model; thus, time and effort of the user setting the data model can be reduced.

### Modification Example 5

In the present embodiment 1, the determination part 3b determines whether or not the delay occurs for each query based on the current response time and the threshold value; however, the configuration is not limited thereto. For example, the determination part 3b may determine whether or not the delay occurs for each query by creating a transition pattern of the response time from the current response time and the past response time and performing mechanical learning similar to the mechanical learning described above on the transition pattern.

### Modification Example 6

Although the delay estimation apparatus 3 and the control apparatus 6 are separately provided in the embodiment 1, the configuration is not limited thereto. For example, although not illustrated in the diagrams, the delay estimation apparatus 3 may include a controller having a function similar to the control apparatus 6 in addition to the acquisition part 3a, the determination part 3b, and the estimation part 3c. The delay estimation system is not limited to the delay estimation system according to the embodiment 1 as long as it has a function similar to the acquisition part 3a and a function similar to the determination part 3b.

### Another Modification Example

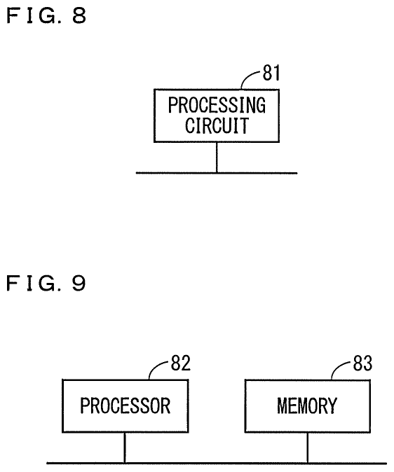

The acquisition part 3a, the determination part 3b, and the estimation part 3c in FIG. 1 described above are referred to as “the acquisition part 3a etc.” hereinafter. The acquisition part 3a etc. is achieved by a processing circuit 81 illustrated in FIG. 8. That is to say, the processing circuit 81 includes: the acquisition part 3a acquiring, for each query, the response time of one or more microservices using the query for the data model in which the plurality of queries are previously associated; the determination part 3b determining whether or not the delay occurs for each query based on the current response time and the past response time; and the estimation part 3c estimating that the delay occurs in at least one of the microservice using the delay query and the query associated with the delay query in the data model. Dedicated hardware may be applied to the processing circuit 81, or a processer executing a program stored in a memory may also be applied. A central processing unit, a processing device, an arithmetic device, a microprocessor, a microcomputer, or a digital signal processor (DSP), for example, falls under the processor, and is provided to a personal computer or a server, for example.

When the processing circuit 81 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 81. Each function of the acquisition part 3a etc. may be achieved by circuits to which the processing circuit is dispersed, or each function of them may also be collectively achieved by one processing circuit.

When the processing circuit 81 is the processor, the functions of the acquisition part 3a etc. are achieved by a combination with software etc. Software, firmware, or software and firmware, for example, fall under the software etc. The software etc. is described as a program and is stored in a memory. As illustrated in FIG. 9, a processor 82 applied to the processing circuit 81 reads out and executes a program stored in a memory 83, thereby achieving the function of each unit. That is to say, the delay estimation apparatus 3 includes the memory 83 for storing a program to resultingly execute steps of, when executed by the processing circuit 81: acquiring, for each query, the response time of one or more microservices using the query for each of the queries for the data model in which the plurality of queries are previously associated; determining whether or not the delay occurs for each query based on the current response time and the past response time; and estimating that the delay occurs in at least one of the microservice using the delay query and the query associated with the delay query in the data model. In other words, this program is also deemed to make a computer execute a procedure or a method of the acquisition part 3a etc. Herein, the memory 83 may be a non-volatile or volatile semiconductor memory such as a random access memory (RAM), a read only memory (ROM), a flash memory, an electrically programmable read only memory (EPROM), or an electrically erasable programmable read only memory (EEPROM), a hard disk drive (HDD), a magnetic disc, a flexible disc, an optical disc, a compact disc, a mini disc, a digital versatile disc (DVD), or a drive device of them, or any storage medium which is to be used in the future.

Described above is the configuration that each function of the acquisition part 3a etc. is achieved by one of the hardware and the software, for example. However, the configuration is not limited thereto, but also applicable is a configuration of achieving a part of the acquisition part 3a etc. by dedicated hardware and achieving another part of them by software, for example. For example, the function of the acquisition part 3a can be achieved by the processing circuit 81 as the dedicated hardware and an acquisition processing circuit, for example, and the function of the other units can be achieved by the processing circuit 81 as the processor 82 reading out and executing the program stored in the memory 83.

As described above, the processing circuit 81 can achieve each function described above by the hardware, the software, or the combination of them, for example.

Contents of the embodiment can be appropriately modified and omitted.

The foregoing description is in all aspects illustrative and does not restrict the disclosure. It is therefore understood that numerous modification examples not illustrated can be devised.

### EXPLANATION OF REFERENCE SIGNS

1 microservice, 3 delay estimation apparatus, 3a acquisition part. 3b determination part, 3c estimation part.

1. A delay estimation apparatus, comprising:
an acquisition circuitry acquiring, for each of a plurality of queries, a response time of one or more microservices using the query for a data model in which the plurality of queries are previously associated; and
a determination circuitry determining whether or not a delay occurs for each of the queries based on the response time currently acquired and the response time acquired in a past time.

2. The delay estimation apparatus according to claim 1, further comprising
an estimation circuitry estimating that the delay occurs in at least one of the microservice using a delay query and one of the queries associated with the delay query in the data model based on the data model and the delay query, the delay query being as one of the queries in which it is determined that a delay occurs.

3. The delay estimation apparatus according to claim 1, wherein
the plurality of queries are previously associated in a hierarchy structure in the data model.

4. The delay estimation apparatus according to claim 2, wherein
the plurality of queries are previously associated in a hierarchy structure in the data model, and
the estimation circuitry estimates that a delay occurs in one of the queries associated with the delay query and positioned in an upper hierarchy than the delay query in the hierarchy structure based on the data model and the delay query.

5. The delay estimation apparatus according to claim 3, wherein
the plurality of queries include at least one of:
a group of a query of a facility, a query of an apparatus, and a query of a sensor sequentially defined from an upper hierarchy of the hierarchy structure;
a group of a query of a year, a query of a month, and a query of a day sequentially defined from an upper hierarchy of the hierarchy structure; and
a group of a query of a building, a query of a floor, and a query of a person sequentially defined from an upper hierarchy of the hierarchy structure.

6. The delay estimation apparatus according to claim 1, wherein
the determination circuitry determines whether or not a delay occurs for each of the queries based on the response time currently acquired and a threshold value, and
the threshold value is determined based on the response time acquired in the past time and weighting of the query.

7. The delay estimation apparatus according to claim 2, wherein
the microservice using the delay query is stopped.

8. The delay estimation apparatus according to claim 2, wherein
the one or more microservices include one microservice and another microservice, and
the estimation circuitry estimates that a delay occurs in the another microservice using the delay query when the delay query is determined in the one microservice based on the data model and the delay query.

9. The delay estimation apparatus according to claim 8, wherein
the another microservice using the delay query is stopped.

10. The delay estimation apparatus according to claim 2, wherein
the one or more microservices include one microservice and another microservice using one of the queries used for the one microservice, and
the estimation circuitry estimates that a delay occurs in a part of the one microservice other than the one of the queries when it is determined that a delay occurs in the one of the queries in the one microservice and it is not determined that a delay occurs in the one of the queries in the another microservice.

11. The delay estimation apparatus according to claim 1, wherein
the data model is created by performing mechanical learning on a name of each of the plurality of queries.

12. A delay estimation method, comprising:
acquiring, for each of a plurality of queries, a response time of one or more microservices using the query for a data model in which the plurality of queries are previously associated; and
determining whether or not a delay occurs for each of the queries based on the response time currently acquired and the response time acquired in a past time.

13. A delay estimation system, comprising:
a function of acquiring, for each of a plurality of queries, a response time of one or more microservices using the query for a data model in which the plurality of queries are previously associated; and
a function of determining whether or not a delay occurs for each of the queries based on the response time currently acquired and the response time acquired in a past time.
